(19) United States
(12) Patent Application Publication
(10) Pub. No.: US 2019/0138424 A1
(43) Pub. Date: May 9, 2019

(54) SYSTEMS AND METHODS FOR SAFELY IMPLEMENTING WEB PAGE UPDATES

(71) Applicant: Facebook, Inc., Menlo Park, CA (US)

(72) Inventors: Pieter David Vanderwerff, Mountain View, CA (US); Jack F. Gill, Brooklyn, NY (US); Bhuwan Bhushan Khattar, Mountain View, CA (US)

(21) Appl. No.: 15/805,999

(22) Filed: Nov. 7, 2017

(51) Int. Cl. G06F 11/36; G06F 9/445

(52) U.S. Cl. CPC G06F 11/362; G06F 8/65

(57) ABSTRACT

Systems, methods, and non-transitory computer-readable media can receive a web page update for a web page, the web page update comprising updated server-side code and updated client-side static resources. One or more unsafe changes are identified in the web page update. A notification is generated notifying a user of the one or more unsafe changes.

### FIELD OF THE INVENTION

The present technology relates to the field of web pages. More particularly, the present technology relates to systems and methods for safely implementing web page updates.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system. In certain scenarios, a user can access the social networking system by using a computing device to load a web page (or web site).

### SUMMARY

Various embodiments of the present disclosure can include systems, methods, and non-transitory computer readable media configured to receive a web page update for a web page, the web page update comprising updated server-side code and updated client-side static resources. One or more unsafe changes are identified in the web page update. A notification is generated notifying a user of the one or more unsafe changes.

In an embodiment, the updated server-side code comprises updated server-side PHP code, and the update client-side static resources comprise updated JavaScript code.

In an embodiment, identifying one or more unsafe changes in the web page update comprises identifying a function in which an input parameter has been removed.

In an embodiment, identifying one or more unsafe changes in the web page update comprises identifying a function in which an input parameter has been changed from a first type to a second type.

In an embodiment, identifying one or more unsafe changes in the web page update comprises identifying a new function that has been added in the web page update.

In an embodiment, implementation of the web page update is prevented based on the one or more unsafe changes.

In an embodiment, a recommendation is generated for how to carry out at least some of the one or more unsafe changes safely.

In an embodiment, identifying one or more unsafe changes in the web page update comprises identifying a function in which an input parameter has been removed, and the generating the recommendation comprises recommending tagging the input parameter with a tag indicating that the input parameter will be removed in a future update.

In an embodiment, identifying one or more unsafe changes in the web page update comprises identifying a function in which an input parameter has been changed from a first type to a second type, and the generating the recommendation comprises: recommending generating a new function rather than changing an input parameter type in an existing function, and recommending modifying the web page update to include a conditional function call in which a function call is selected based on a determination of whether or not client-side static resources are updated.

In an embodiment, the determination of whether or not client-side static resources are updated is made based on whether or not the new function exists in the client-side static resources.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a push safety module, according to an embodiment of the present disclosure.

FIG. 2 illustrates an example unsafe change determination module, according to an embodiment of the present disclosure.

FIG. 3 illustrates an example scenario associated with safely updating a function to remove an input parameter, according to an embodiment of the present disclosure.

FIG. 4 illustrates an example method associated with safely implementing web page updates, according to an embodiment of the present disclosure.

FIG. 5 illustrates an example method associated with safely updating a function to remove an input parameter, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Safe Implementation of Web Page Updates

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system. In certain scenarios, a user can access the social networking system by using a computing device to load a web page (or web site).

When a user attempts to access a web page, such as a web page on a social networking system, a client computing device used by the user can transmit a request for the web page. For example, a user can use a web browser application on the client computing device to try to access and view a web page, and the client computing device can transmit a corresponding request for the web page. The request can be received at one or more web servers associated with the web page. The one or more web servers can communicate with the web browser application on the client computing device to transmit appropriate resources to the client computing device so that the web browser application can load the web page.

In order for a web browser application to communicate with one or more web servers associated with a web page, the web browser application can download certain resources that facilitate such communication. For example, these resources may be referred to as client-side static resources, and can include JavaScript code and/or CSS code. Static resources on a client computing device can be used to communicate with server-side code, such as PHP code, residing on the one or more web servers. The server-side code and the client-side static resources may be complementary, such that when the server-side code transmits information to the client computing device, the client-side static resources will know how to interpret the information and act accordingly. For example, PHP code on a server (server-side code) can be used to interact with JavaScript code on a client computing device (client-side static resources). The server-side PHP code can transmit directives to a client device to be run by the client-side JavaScript code. These directives can include functions and input parameters to those functions. The JavaScript code can take a function and one or more input parameters and take appropriate action based on the function and the one or more input parameters.

When a web page provider, such as a social networking system, wants to update a web page, the web page provider will generally update server-side code residing on one or more web servers. Similarly, client-side static resources can also be updated so that they can effectively communicate with the updated server-side code. However, web page providers may have a very large number of web servers, with some larger providers having hundreds of thousands of web servers. Updated server-side code must be pushed to each of these web servers. It can be appreciated that this update push process can involve significant amounts of time, sometimes on the order of days. This can cause a situation in which, during the update push, certain web servers have updated server-side code while others have non-updated server-side code. Similarly, under conventional approaches, during the update push period, certain client computing devices may have updated client-side static resources while other client computing devices may have non-updated client-side static resources.

In such scenarios, non-updated client-side static resources may attempt to communicate with updated server-side code and/or updated client-side static resources may attempt to communicate with non-updated server-side code. In other words, there may be a version mismatch between client-side static resources and server-side code. Under conventional approaches, this can be problematic, as changes in either the updated client-side static resources and/or the updated server-side code may make them incompatible with non-updated server-side code and/or non-updated client-side static resources. For example, consider an example scenario in which server-side PHP code and client-side JavaScript code include a function “foo(number),” where the function “foo” receives as an input parameter a number. In this scenario, the PHP code can send a directive to the client-side JavaScript code that identifies the function and an input value for the function, e.g., [‘foo’, 3]. Now consider a scenario in which the “foo” function is updated to receive a string as an input parameter instead of a number, i.e. “foo(string).” If a client computing device has the older version of JavaScript code, then the non-updated “foo” function on the client computing device still requires a number as an input parameter. However, if a server has the latest update to its PHP code, the updated PHP code will try to transmit a directive which includes the function “foo” with a string, e.g., [‘foo’, “hello” ]. In this case, the client computing device may try to perform numerical operations on the string “hello”, because the older, non-updated JavaScript code on the client device assumes it is receiving a number as an input parameter for the function “foo.” Similarly, if a client computing device has updated JavaScript, but a communicating web server has non-updated PHP code, then the client device may expect to receive a string as an input to the function “foo,” but the non-updated server may transmit a number as an input parameter. These errors in communication caused by version mismatches are generally temporary, because, eventually, all client computing devices and web servers should become updated with the latest updates. However, during update push periods, these communication errors caused by version mismatches can cause potentially serious problems. These problems can be particularly troublesome for web pages that are updated frequently, resulting in frequent update push periods with increased potential for version mismatches.

An improved approach rooted in computer technology overcomes the foregoing and other disadvantages associated with conventional approaches specifically arising in the realm of computer technology. In general, when a user attempts to update a web page, the update can be analyzed to identify any potentially unsafe changes. If the update includes any unsafe changes, the user can be notified so that he or she is made aware of these issues and can fix them. In certain embodiments, a user may be prevented from committing any updates if unsafe changes are detected. Identifying unsafe changes in a web page update can comprise identifying unsafe changes in a server-side code update and/or a client-side static resource update. Analysis and identification of potentially unsafe changes can include analysis of any functions that are changed within server-side code and/or client-side static resources. If a function is changed, a current function (i.e., a currently version of the function that exists before an update is pushed out) can be compared with an updated function (i.e., the updated version of the function that would be implemented in an update) to determine whether the change to the function is safe or unsafe. For example, updated server-side PHP code can be analyzed to identify all client-side JavaScript function calls included in the updated server-side PHP code. For each function call in the updated server-side code, it can be determined (1) whether the function currently exists; (2) if the function currently exists, what types of input parameters the current function is configured to receive; (3) whether the input parameters to the function call in the updated server-side code match the input parameters for the currently existing function (i.e., the function remains unchanged in the update) or whether the input parameters to the function in the updated server-side code are different from the input parameters for the currently existing function (i.e., the function is being changed and/or updated in the update). If a function is being changed in a server-side code update, a determination can be made as to whether or not the change is a safe change or an unsafe change. If any unsafe changes exist in a web page update (e.g., within the server-side code and/or the client-side static resources), a notification can be generated alerting a user to any unsafe changes. Furthermore, if any unsafe changes exist in a web page update, the web page update can be prevented from being committed and/or implemented. These features and others are described in greater detail herein.

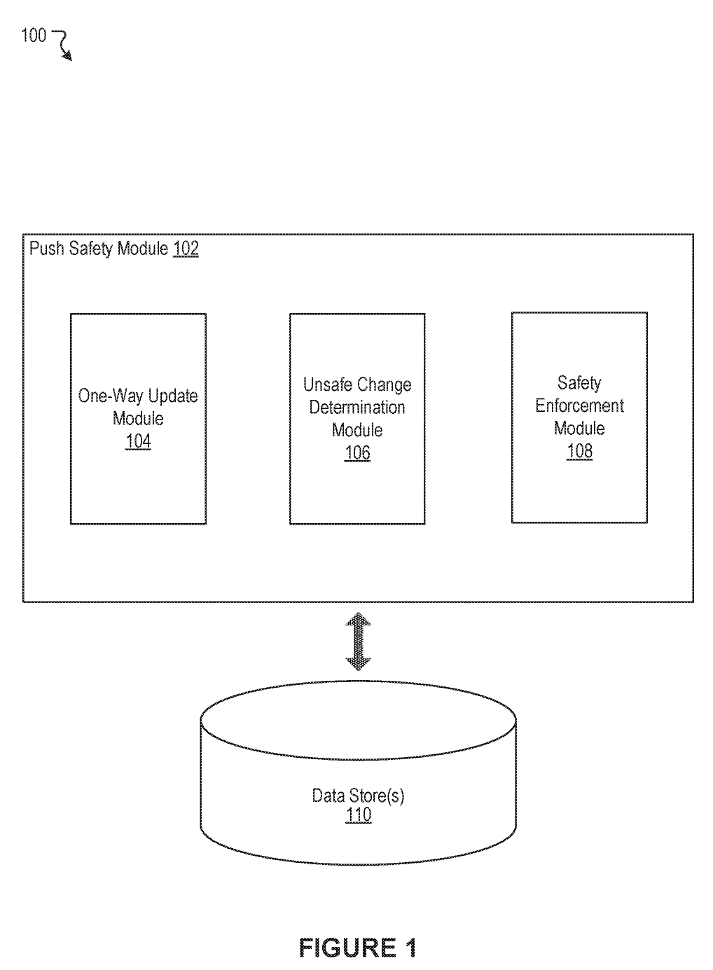

FIG. 1 illustrates an example system 100 including a push safety module 102, according to an embodiment of the present disclosure. The push safety module 102 can be configured to receive an update to a web page. The update can include updated server-side code as well as corresponding updated client-side static resources. For example, the updated server-side code can include updated PHP code, and the updated client-side static resources can include updated JavaScript code. The push safety module 102 can inspect the web page update (e.g., inspect the updated server-side code and/or the updated client-side static resources) to determine whether any functions have been modified in the update. If any functions have been modified, the push safety module 102 can determine whether changes to the function are safe changes, or whether they are unsafe changes. If an unsafe change is detected, the push safety module 102 can generate a notification informing a user of any unsafe changes. For example, when a user attempts to commit code that includes any unsafe changes, a user interface being presented to the user can present an error or warning notifying the user that the code contains unsafe changes. In certain embodiments, if an unsafe change is detected in a web page update, the push safety module 102 can prevent the web page update from being implemented.

As shown in the example of FIG. 1, the push safety module 102 can include a one-way update module 104, an unsafe change determination module 106, and a safety enforcement module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the push safety module 102 can be implemented in any suitable combinations.

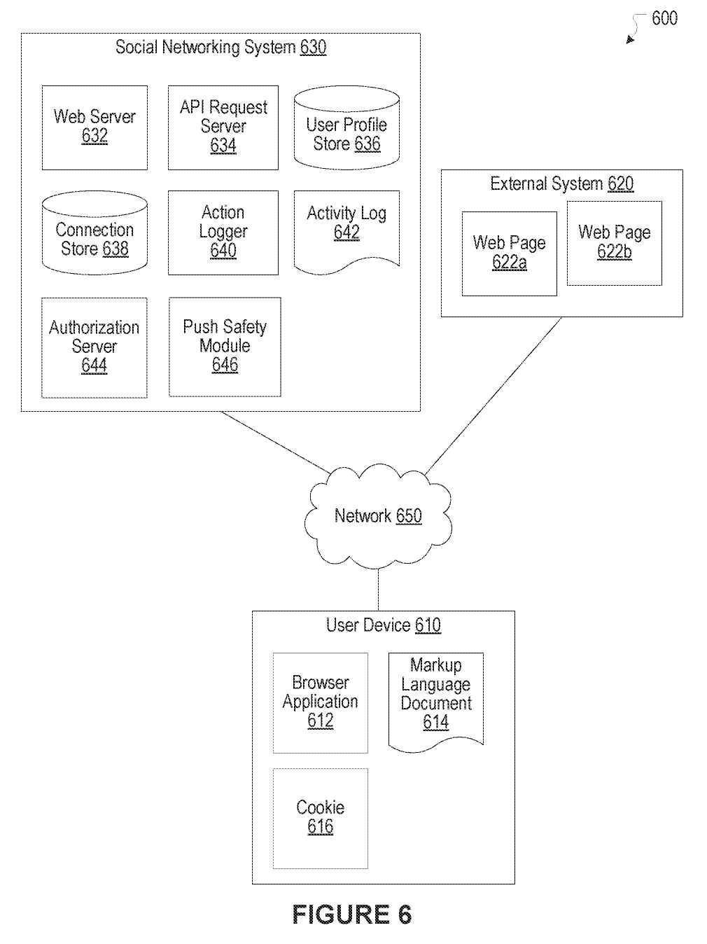

In some embodiments, the push safety module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the push safety module 102 can be implemented, in part or in whole, as software running on one or more computing devices or systems, such as on a user or client computing device. For example, the push safety module 102, or at least a portion thereof, can be implemented as or within an application (e.g., app), a program, or an applet, etc., running on a user computing device or a client computing system, such as the user device 610 of FIG. 6. In another example, the push safety module 102, or at least a portion thereof, can be implemented using one or more computing devices or systems that include one or more servers, such as network servers or cloud servers. In some instances, the push safety module 102 can, in part or in whole, be implemented within or configured to operate in conjunction with a social networking system (or service), such as the social networking system 630 of FIG. 6. It should be understood that there can be many variations or other possibilities.

The push safety module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the push safety module 102. For example, the data store 110 can store various versions of web pages, function information including current and/or earlier versions of various functions, function change and/or modification rules, and the like. It is contemplated that there can be many variations or other possibilities.

The one-way update module 104 can be configured to ensure that client computing devices are not provided with updated client-side static resources for a web page until all web servers associated with the web page are updated with corresponding updated server-side code. In other words, the one-way update module 104 ensures that client-side static resources on client computing devices are always either one or more versions behind the server-side code, or at the same version as the server-side code, but never ahead of the server-side code on any web server. This is useful for several reasons. As discussed above, under conventional approaches, version mismatches can occur in either direction between a client computing device and a web server. For example, in a first scenario, a version mismatch can occur when a client computing device has an updated version of client-side static resources while a web server has non-updated server-side code, and a version mismatch can also occur, in a second scenario, when a client computing device has non-updated client-side static resources while a web server has updated server-side code. Either of these scenarios can result in communication/processing errors. However, by ensuring that client-side static resources never move ahead of any web server's server-side code, the one-way update module 104 can ensure that the first scenario can never occur, i.e., a client computing device having updated client-side static resources while a web server has non-updated server-side code. As such, this first scenario can be suitably addressed. Further solutions can focus on the second scenario of a web server potentially having updated server-side code while communicating with a client computing device that has non-updated client-side static resources.

The unsafe change determination module 106 can be configured to identify any changes to functions in a web page update, and to determine whether such changes are safe changes or unsafe changes. Certain updates and/or modifications to functions can be considered “safe” changes, while others may be considered “unsafe” changes. Safe changes can include any changes that can be processed without causing errors even if there is a version mismatch between server-side code and client-side static resources. Conversely, unsafe changes can include those changes that would result in errors if there was a version mismatch between server-side code and client-side static resources. One example of a safe change is a change to a function which adds additional input parameters to the function, while maintaining all previous input parameters. For example, consider an example function “foo” which takes a number as a first input parameter and a string as a second input parameter, i.e., foo(number, string). An update to a web page might include a change to the function foo such that it also takes as a third input parameter a list of numbers, such that the updated function would be foo(number, string, list<number>). This change would be considered a “safe” change because the added input parameter would not cause any errors, even if there is a version mismatch. This is due to the fact that even if a client computing device having non-updated client-side static resources receives from server-side code a function call with the updated “foo” function, which includes three input parameters instead of two, the non-updated client-side static resources can simply use the first two input parameters and ignore the third input parameter. For example, if updated server-side code transmitted a directive [‘foo’, 3, “hello”, [7, 12, 14]], non-updated client-side static resources could utilize the number “3” and the string “hello” while ignoring the list of numbers. As such, despite a version mismatch, no error occurs.

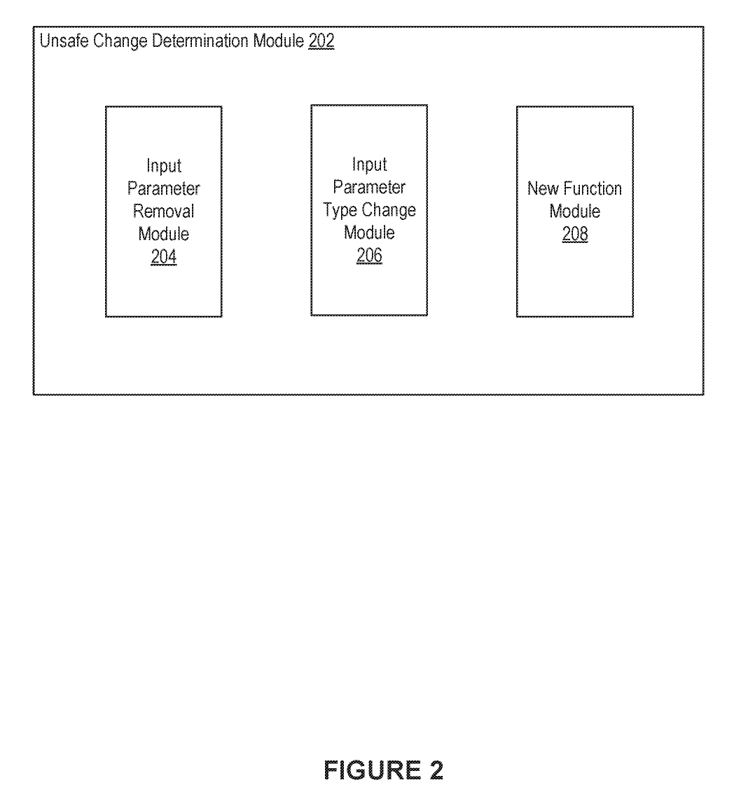

Examples of “unsafe” changes can include changes in which a function has an input parameter removed, a function has an input parameter type changed, and/or a new function is added. Each of these changes would potentially lead to errors if updated server-side code was interacting with non-updated client-side static resources. These example scenarios and the unsafe change determination module 106 are described in greater detail herein with reference to FIG. 2.

The safety enforcement module 108 can be configured to notify a user of any unsafe changes identified in a web page update. As described above, in various embodiments, a web page update can include changes to server-side code and corresponding changes to client-side static resources. When a user creates a web page update, and takes steps to implement the web page update, the safety enforcement module 108 can generate a notification informing the user of any unsafe changes detected in the web page update. For example, when the user attempts to commit the update, the update can be analyzed (e.g., by the unsafe change determination module 106), and the safety enforcement module 108 can generate a notification if any unsafe changes are detected. In certain embodiments, the safety enforcement module 108 can be configured to prohibit commitment and/or implementation of an update if unsafe changes are detected.

FIG. 2 illustrates an example unsafe change determination module 202 configured to analyze a web page update and identify any unsafe changes, according to an embodiment of the present disclosure. In some embodiments, the unsafe change determination module 106 of FIG. 1 can be implemented as the unsafe change determination module 202. As shown in the example of FIG. 2, the unsafe change determination module 202 can include an input parameter removal module 204, an input parameter type change module 206, and a new function module 208.

The input parameter removal module 204 can be configured to identify changes to functions in which one or more input parameters are being removed from a function. In various embodiments, one example of an “unsafe” change can include a change in which a function has one or more input parameters removed. For example, consider a function foo(number, string). An example update could modify the function “foo” such that the first input parameter is removed, i.e., foo(number, string) is changed to foo(string). In this case, if non-updated client-side static resources receive from updated server-side code an updated function call which includes only a string as an input parameter, the non-updated client-side static resources could not properly process the function call because the non-updated client-side static resources would require both a number and a string for the function “foo.” As such, an error would occur and the function call could not be processed. Therefore, the input parameter removal module 204 can identify this change as an unsafe change.

In certain embodiments, if the input parameter removal module 204 detects an unsafe change in which an input parameter is being removed from a function, a recommendation can be made to the user that informs the user of a safe way in which to implement this change. In certain embodiments, the input parameter removal module 204 can implement a “deprecated” input parameter type tag that allows for gradual, safe removal of input parameters from a function. If a user wishes to update a function such that an input parameter is removed from the function, the user can modify the input parameter with a “deprecated” type tag. For example, consider once again the example function foo(number, string). If a user wishes to remove the second input parameter, the user can update the function by tagging the second input parameter as “deprecated,” i.e., foo(number, deprecated<string>). This updated function with the deprecated tag indicates that the updated server-side code must still transmit a string as a second input parameter for the function “foo” because there are still non-updated client-side static resources that will expect the second input parameter. However, the deprecated type tag also indicates to other users that in future versions, the second input parameter will be removed. The deprecated type tag indicates that once all web servers and client computing devices have been updated with the latest server-side code and client-side static resources, the function “foo” will no longer rely on the second input parameter. As such, once all web servers and client computing devices have been updated, a second, subsequent update can be issued in which the “deprecated” input parameter can be removed completely. The input parameter removal module 204 can be configured to permit removal of a “deprecated” input parameter, but prevent and/or notify a user of any non-deprecated input parameters being removed.

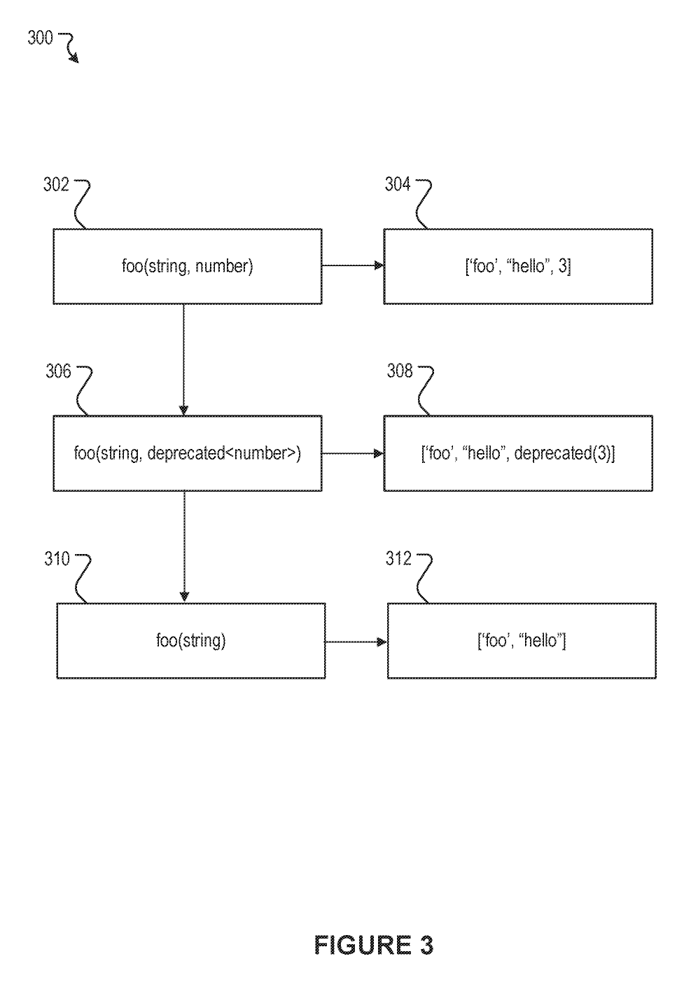

FIG. 3 illustrates an example scenario 300 associated with safely updating a function to remove an input parameter, according to an embodiment of the present disclosure. In the example scenario 300, a function foo takes a string as a first input parameter and a number as a second input parameter at block 302. Block 304 illustrates an example function call for the function foo as recited in block 302, i.e., [‘foo’, “hello”, 3]. At block 306, the function foo has been updated such that the second input parameter is marked as “deprecated.” In this first updated version of foo, server-side code still transmits as part of its function call a number as the second input parameter, but the number is tagged as “deprecated.” The “deprecated” tag inform others that in future updates, the second input parameter will be removed. Block 308 illustrates an example function call for the updated function foo as recited in block 306, i.e., [‘foo’, “hello”, deprecated(3)]. At block 310, the function foo has been updated once again to remove the second input parameter. In certain embodiments, the update in block 310 can occur after all web servers in a set of web servers associated with a web page have been updated with updated server-side code from block 306, and all client devices in a set of client devices have been updated with corresponding updated client-side static resources from block 306. When all client devices and web servers have been updated with the intermediate update of block 3016, there should no longer be significant risk that a client device or web server will try to rely on the second input parameter. As such, the second input parameter can now be removed without risk of error. Block 312 illustrates an example function call for the final updated function foo recited in block 310, i.e., [‘foo’, “hello” ].

Returning to FIG. 2, the input parameter type change module 204 can be configured to identify changes to functions in which one or more input parameters are changed from one type to another. Another example of an “unsafe” change can include a change in which a function has an input parameter type changed. For example, consider an example function foo(number). An update could modify the function “foo” such that the input parameter is changed from a number to a string, i.e., foo(number) is changed to foo(string). Such a change would result in a processing error if there was a version mismatch between server-side code and client-side static resources. If updated server-side code transmitted a function call for “foo” which included as an input parameter a string, non-updated client-side static resources could not properly process the function call because the non-updated client-side static resources require a number as an input for the function “foo.” The non-updated client-side static resources might, for example, try to perform numerical operations on a string, resulting in erroneous output or making it impossible to process the operations at all.

In certain embodiments, if the input parameter type change module 206 detects an unsafe change in which an input parameter type is changed from one type to another, a recommendation can be made to the user for a safe way in which to implement this change. For example, the safety enforcement module 108 of FIG. 1 can generate a recommendation for a user to create a new function rather than changing an input parameter type of a currently existing function. The notification generated for the user can also recommend adding code to the web page update which would account for potential version mismatches. For example, if a user wishes to change foo(number) into foo(string), as discussed above, this would be an impermissible, unsafe change. However, rather than change an existing function, the user can generate a new function, foo2(string). In order to account for potential version mismatches, a recommendation can be generated which recommends that the user include code that is consistent with the following pseudo-code:

foo(number)
foo2(string)
if(foo2 exists) {

[foo2, “hello”]

}
else {

[foo, 3]

}

By including the pseudo-code shown above, the update can include conditional function calls which select a function call based on whether or not the client-side static resources are updated. If client-side static resources are updated, then foo2 would exist, satisfying the condition “if(foo2 exists).” In such a scenario, the function call [foo2, “hello” ] would be transmitted from the updated server-side code to the updated client-side static resources. However, if the client-side static resources are not updated, then foo2 would not exist (because it is a new function), and the function call [foo, 3] would be transmitted from the updated server-side code to the non-updated client-side static resources.

The new function module 208 can be configured to identify when a new function has been added in a web page update. In various embodiments, another example of an “unsafe” change can include a change in which a new function is created. If a function is newly added in an update to a web page, then, once again, version mismatch errors could occur. If updated server-side code issues a function call using a brand new function, then non-updated client-side static resources could not process the function call, as the function would not exist within the non-updated client-side static resources.

In certain embodiments, if the new function module 208 detects an unsafe change in which a new function has been added, a recommendation can be made to the user for a safe way in which to implement this change. For example, the safety enforcement module 108 of FIG. 1 can generate a recommendation for a user to add code to the web page update (e.g., to the server-side code) which would account for potential version mismatches. For example, if a user wishes to add a new function, the user can include code that is consistent with the following pseudo-code to account for potential version mismatches:

newfunction( )
if(newfunction exists) {

[newfunction]

}

In other words, the update can include conditional function calls which transmit a function call based on whether or not the client-side static resources are updated. If client-side static resources are updated, then newfunction( ) would exist, satisfying the condition “if(newfunction exists)”. In this case, the function call [newfunction] can be transmitted. However, if the client-side static resources are not updated, then newfunction( ) would not exist (because it is a new function), and no function call is sent.

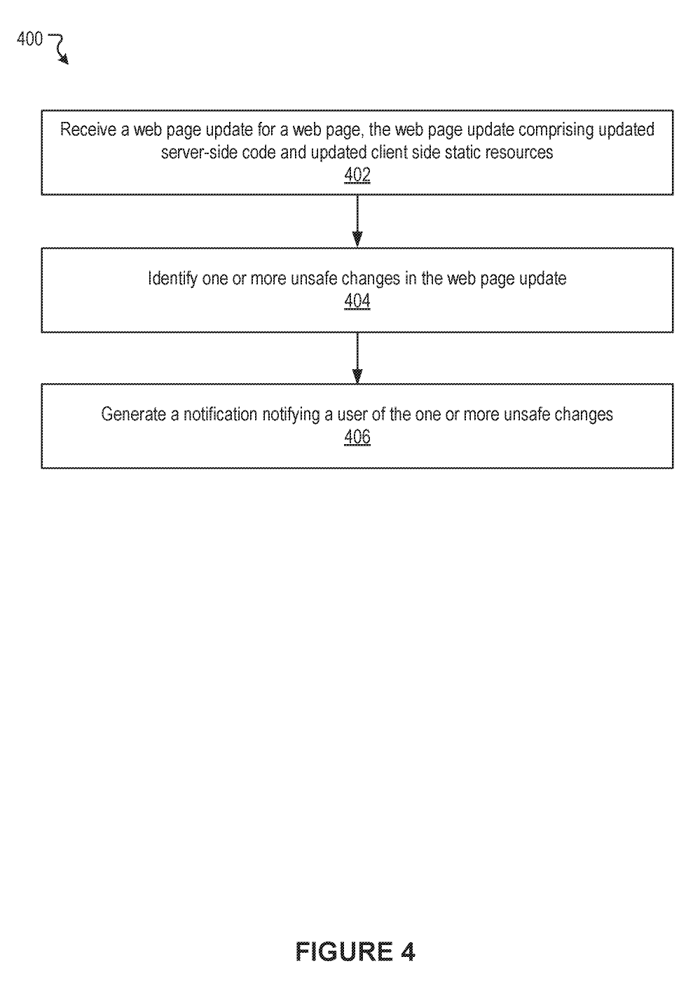

FIG. 4 illustrates an example method 400 associated with safely implementing web page updates, according to an embodiment of the present disclosure. It should be appreciated that there can be additional, fewer, or alternative steps performed in similar or alternative orders, or in parallel, within the scope of the various embodiments discussed herein unless otherwise stated.

At block 402, the example method 400 can receive a web page update for a web page, the web page update comprising updated server-side code and updated client-side static resources. At block 404, the example method 400 can identify one or more unsafe changes in the web page update. At block 406, the example method 400 can generate a notification notifying a user of the one or more unsafe changes.

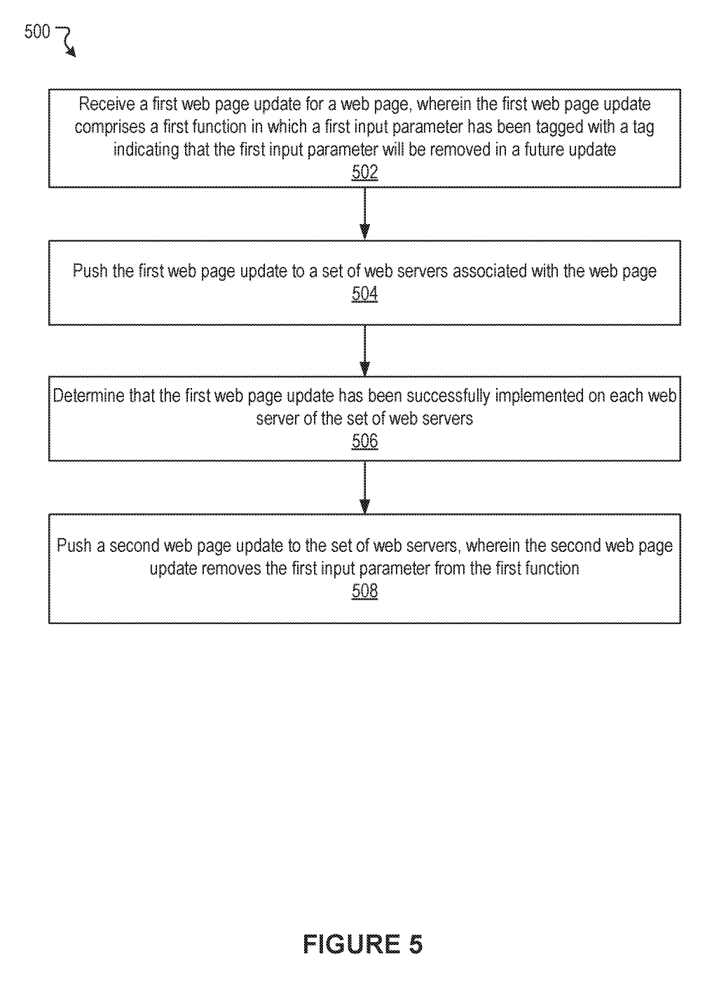

FIG. 5 illustrates an example method 500 associated with safely updating a function to remove an input parameter, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive a first web page update for a web page, wherein the first web page update comprises a first function in which a first input parameter has been tagged with a tag indicating that the first input parameter will be removed in a future update. At block 504, the example method 500 can push the first web page update to a set of web servers associated with the web page. At block 506, the example method 500 can determine that the first web page update has been successfully implemented on each web server of the set of web servers. At block 508, the example method 500 can push a second web page update to the set of web servers, wherein the second web page update removes the first input parameter from the first function.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a push safety module 646. The push safety module 646 can, for example, be implemented as the push safety module 102, as discussed in more detail herein. As discussed previously, it should be appreciated that there can be many variations or other possibilities. For example, in some embodiments, one or more functionalities of the push safety module 646 can be implemented in the user device 610.

### Hardware Implementation

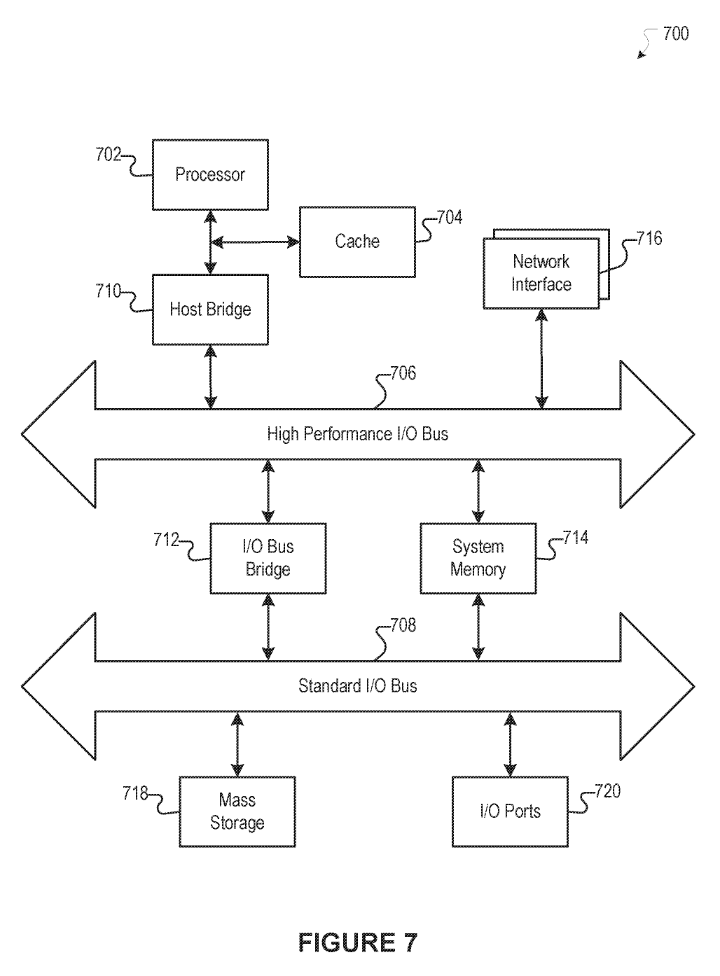

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
receiving, by a computing system, a web page update for a web page, the web page update comprising updated server-side code and updated client-side static resources;
identifying, by the computing system, one or more unsafe changes in the web page update that will result in a version mismatch incompatibility;
generating, by the computing system, a notification notifying a user of the one or more unsafe changes; and
generating, by the computing system, a recommendation for modifying the web page update, wherein the recommendation provides an alternative way to implement at least one of the one or more unsafe changes.

2. The computer-implemented method of claim 1, wherein
the updated server-side code comprises updated server-side PHP code, and,
the updated client-side static resources comprise updated JavaScript code.

3. The computer-implemented method of claim 1, wherein identifying one or more unsafe changes in the web page update comprises identifying a function in which an input parameter has been removed.

4. The computer-implemented method of claim 1, wherein identifying one or more unsafe changes in the web page update comprises identifying a function in which an input parameter has been changed from a first type to a second type.

5. The computer-implemented method of claim 1, wherein identifying one or more unsafe changes in the web page update comprises identifying a new function that has been added in the web page update.

6. The computer-implemented method of claim 1, further comprising preventing implementation of the web page update based on the one or more unsafe changes.

7. (canceled)

8. The computer-implemented method of claim 1, wherein
identifying one or more unsafe changes in the web page update comprises identifying a function in which an input parameter has been removed, and
the generating a recommendation comprises recommending tagging the input parameter with a tag indicating that the input parameter will be removed in a future update.

9. The computer-implemented method of claim 1, wherein
identifying one or more unsafe changes in the web page update comprises identifying a function in which an input parameter has been changed from a first type to a second type, and
the generating a recommendation comprises
recommending generating a new function rather than changing an input parameter type in an existing function, and
recommending modifying the web page update to include a conditional function call in which a function call is selected based on a determination of whether or not client-side static resources are updated.

10. The computer-implemented method of claim 9, wherein the determination of whether or not client-side static resources are updated is made based on whether or not the new function exists in the client-side static resources.

11. A system comprising:
at least one processor; and
a memory storing instructions that, when executed by the at least one processor, cause the system to perform a method comprising:
receiving a web page update for a web page, the web page update comprising updated server-side code and updated client-side static resources;
identifying one or more unsafe changes in the web page update that will result in a version mismatch incompatibility;
generating a notification notifying a user of the one or more unsafe changes; and
generating a recommendation for modifying the web page update, wherein the recommendation provides an alternative way to implement at least one of the one or more unsafe changes.

12. The system of claim 11, wherein
the updated server-side code comprises updated server-side PHP code, and,
the updated client-side static resources comprise updated JavaScript code.

13. The system of claim 11, wherein identifying one or more unsafe changes in the web page update comprises identifying a function in which an input parameter has been removed.

14. The system of claim 11, wherein identifying one or more unsafe changes in the web page update comprises identifying a function in which an input parameter has been changed from a first type to a second type.

15. The system of claim 11, wherein identifying one or more unsafe changes in the web page update comprises identifying a new function that has been added in the web page update.

16. A non-transitory computer-readable storage medium including instructions that, when executed by at least one processor of a computing system, cause the computing system to perform a method comprising:
receiving a web page update for a web page, the web page update comprising updated server-side code and updated client-side static resources;
identifying one or more unsafe changes in the web page update that will result in a version mismatch incompatibility;
generating a notification notifying a user of the one or more unsafe changes; and
generating a recommendation for modifying the web page update, wherein the recommendation provides an alternative way to implement at least one of the one or more unsafe changes.

17. The non-transitory computer-readable storage medium of claim 16, wherein
the updated server-side code comprises updated server-side PHP code, and,
the updated client-side static resources comprise updated JavaScript code.

18. The non-transitory computer-readable storage medium of claim 16, wherein identifying one or more unsafe changes in the web page update comprises identifying a function in which an input parameter has been removed.

19. The non-transitory computer-readable storage medium of claim 16, wherein identifying one or more unsafe changes in the web page update comprises identifying a function in which an input parameter has been changed from a first type to a second type.

20. The non-transitory computer-readable storage medium of claim 16, wherein identifying one or more unsafe changes in the web page update comprises identifying a new function that has been added in the web page update.
